(19) United States
(12) Patent Application Publication
(10) Pub. No.: US 2023/0017248 A1
(43) Pub. Date: Jan. 19, 2023

(54) INFORMATION PROVIDING METHOD

(71) Applicant: NEC Corporation, Minato-ku, Tokyo (JP)

(72) Inventors: Daisuke Ikefuji, Tokyo (JP); Shigeki Shinoda, Tokyo (JP); Mikiko Makise, Tokyo (JP); Norifumi Yamazaki, Tokyo (JP); Tetsuo Nakagawa, Tokyo (JP); Akiko Tashiro, Tokyo (JP); Masaki Sawada, Tokyo (JP); Shinichiro Ikeda, Tokyo (JP)

(73) Assignee: NEC Corporation, Minato-ku, Tokyo (JP)

(21) Appl. No.: 17/782,918

(22) PCT Filed: Dec. 20, 2019
(86) PCT No.: PCT/JP2019/050113

§ 371 Date: Jun. 6, 2022

(51) Int. Cl. G08B 21/10; G06T 7/70; G06V 20/52

(52) U.S. Cl. CPC G08B 21/10; G06T 7/70; G06V 20/52; G06T 2207/30232

(57) ABSTRACT

An information providing system 100 of the present invention includes an acquisition means 121 for acquiring disaster information and acquiring user information that is information related to a user, a generation means 122 for, on the basis of the disaster information and the user information, generating provided information including a captured image that is an image obtained by capturing a predetermined place, and a providing means 123 for providing an information processing device of the user with the provided information.

### TECHNICAL FIELD

The present invention relates to an information providing method, an information providing system, and a program for providing information related to a disaster.

### BACKGROUND ART

A disaster may occur due to a natural phenomenon such as an earthquake or a typhoon or an artificial reason. In the case of such a disaster, information is collected by institutions such as a local government, a central government, and a professional service provider, and the institutions provide warning information related to the disaster to general users by means of street announcement, television, radio, and the Internet using medium such as voice and images. For example, as warning information, there is information including images and videos representing the situation of a disaster, and text and sounds indicating that evacuation is needed.

Patent Literature 1 discloses a system providing warning information related to a disaster. Patent Literature 1 describes that a disaster information providing apparatus calculates the degree of danger on the basis of disaster information, and outputs warning information corresponding to the degree of danger from a presentation unit. As an example, as warning information, a disaster information providing apparatus provides general users with messages by an alarm sound and a voice, videos, and images.
Patent Literature 1: WO 2014/097607 A

### SUMMARY

However, in the art of Patent Literature 1, since the warning information to be provided to the user from the disaster information providing apparatus is provided to all general users, the content is uniform. Therefore, there is a case where general users cannot determine whether or not the provided warning information is a content corresponding to himself/herself, and cannot clearly recognize the degree of danger by the disaster. In that case, even though the content of the warning information prompts evacuation and taking measures, there is a problem that general users do not behave appropriately such as evacuating and taking measures in accordance with the content.

Therefore, an object of the present invention is to provide an information providing method, an information providing device, and a program capable of solving the aforementioned problem, that is, a problem that users may not appropriately take action with respect to a disaster.

An information providing method according to one aspect of the present invention is configured to

acquire disaster information, and acquire user information that is information related to a user,

on the basis of the disaster information and the user information, generate provided information including a captured image that is an image obtained by capturing a predetermined place, and

provide an information processing device of the user with the provided information.

Further, an information providing system according to one aspect of the present invention is configured to include

an acquisition means for acquiring disaster information and acquiring user information that is information related to a user,

a generation means for, on the basis of the disaster information and the user information, generating provided information including a captured image that is an image obtained by capturing a predetermined place, and

a providing means for providing an information processing device of the user with the provided information.

A program according to one aspect of the present invention is configured to cause an information processing device to execute processing to

acquire disaster information, and acquire user information that is information related to a user,

on the basis of the disaster information and the user information, generate provided information including a captured image that is an image obtained by capturing a predetermined place, and

provide an information processing device of the user with the provided information.

With the configurations described above, the present invention enables uses to appropriately take action with respect to a disaster.

### BRIEF DESCRIPTION OF DRAWINGS

FIG. 1 is a block diagram illustrating a configuration of an information providing system according to a first exemplary embodiment of the present invention.

FIG. 2 is a block diagram illustrating a configuration of the information processing system disclosed in FIG. 1.

FIG. 3 illustrates an example of information stored in the information providing system disclosed in FIG. 1.

FIG. 4 illustrates an example of information stored in the information providing system disclosed in FIG. 1.

FIG. 5 illustrates an example of information stored in the information providing system disclosed in FIG. 1.

FIG. 6 illustrates an example of information stored in the information providing system disclosed in FIG. 1.

FIG. 7A illustrates exemplary processing performed by the information providing system disclosed in FIG. 1.

FIG. 7B illustrates exemplary processing performed by the information providing system disclosed in FIG. 1.

FIG. 7C illustrates exemplary processing performed by the information providing system disclosed in FIG. 1.

FIG. 7D illustrates exemplary processing performed by the information providing system disclosed in FIG. 1.

FIG. 8 illustrates a flow of information between devices constituting the information providing system disclosed in FIG. 1.

FIG. 9 is a flowchart illustrating an operation of the information providing system disclosed in FIG. 1.

FIG. 10 is a flowchart illustrating an operation of the information providing system disclosed in FIG. 1.

FIG. 11 is a block diagram illustrating a hardware configuration of an information providing system according to a second exemplary embodiment of the present invention.

FIG. 12 is a block diagram illustrating a configuration of the information providing system according to the second exemplary embodiment of the present invention.

FIG. 13 is a flowchart illustrating an operation of the information providing system according to the second exemplary embodiment of the present invention.

### EXEMPLARY EMBODIMENTS

### First Exemplary Embodiment

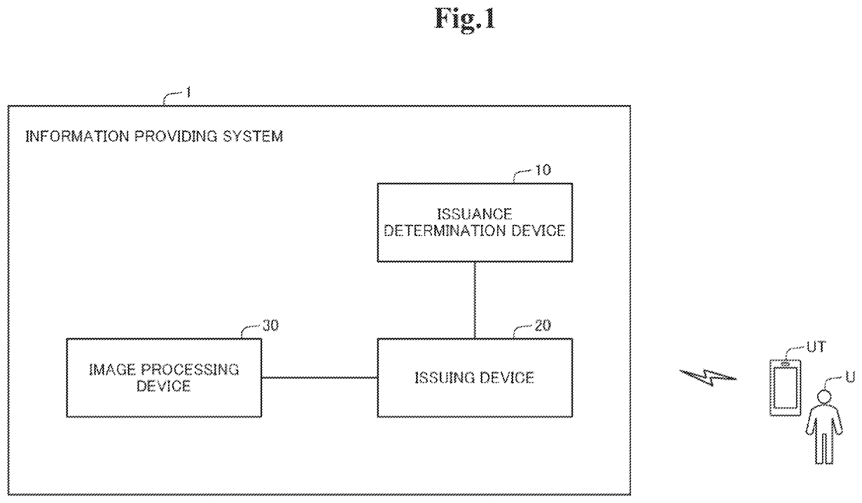

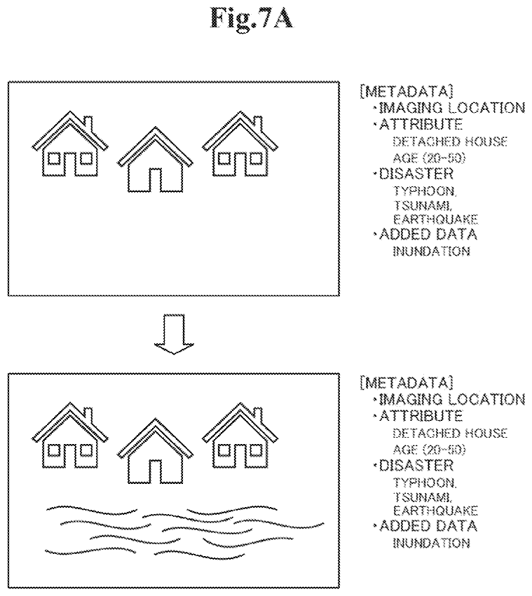

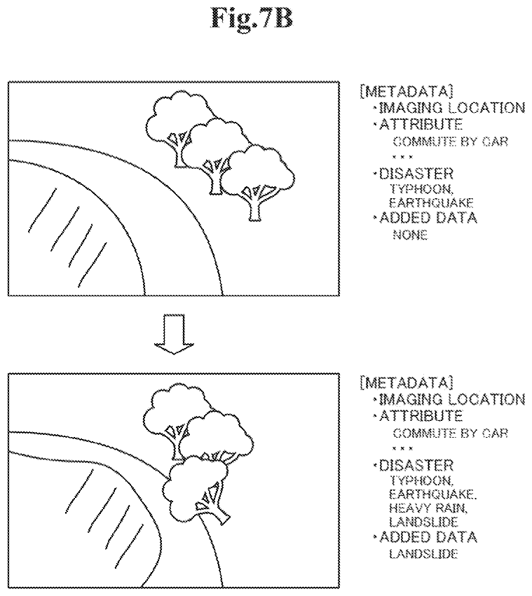

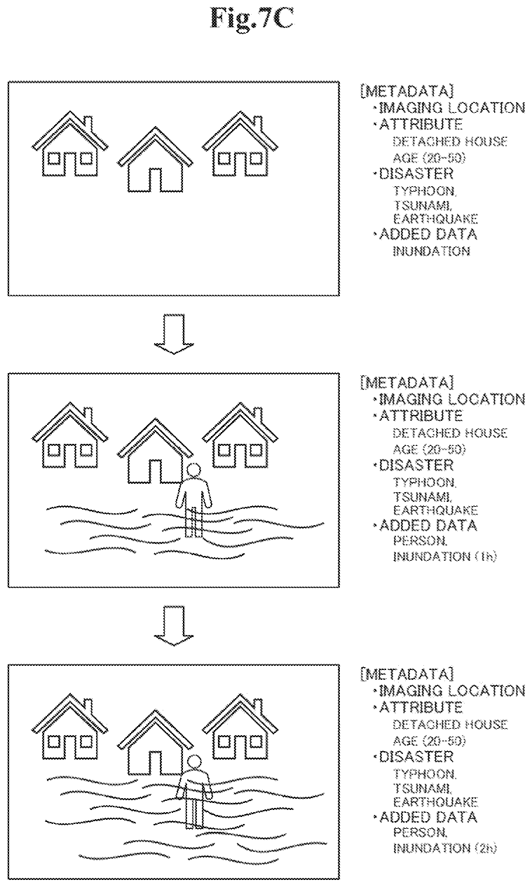

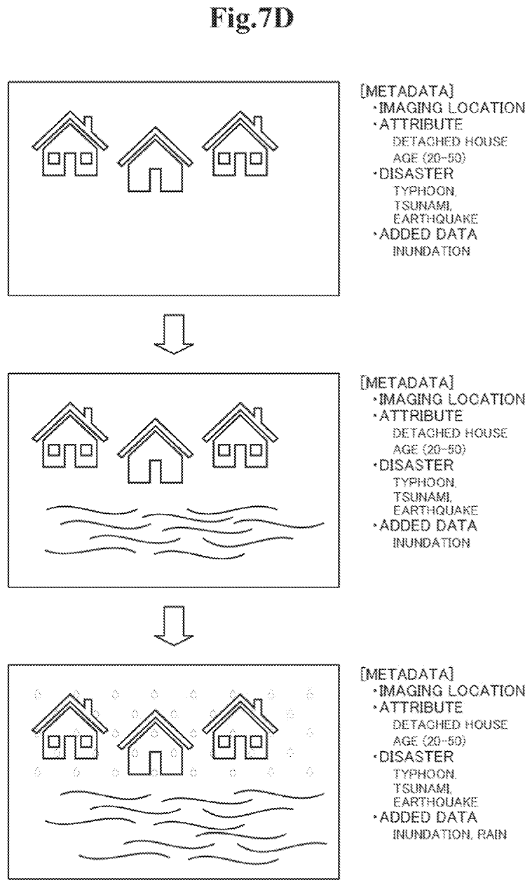

A first exemplary embodiment of the present invention will be described with reference to FIGS. 1 to 10. FIGS. 1 to 6 are diagrams for explaining a configuration of an information providing system, and FIGS. 7 to 10 are illustrations for explaining the processing operation of the information providing system.

The information providing system of the present invention is for providing a person U who is a general user with information related to a disaster. In particular, in the present embodiment, the information providing system provides image information with which the person U can recognize the content of the disaster.

[Configuration]

As illustrated in FIG. 1, an information providing system 1 includes an issuance determination device 10 that determines whether or not to issue a warning of a disaster, an issuing device 20 that issues a warning of a disaster, and an image processing device 30 that processes an image included in provided information to be provided to the person U when issuance is made. The issuing device 20 is connected to a person's terminal UT that is an information processing terminal such as a smartphone held by the person U, over a network. Hereinafter, the components will be described.

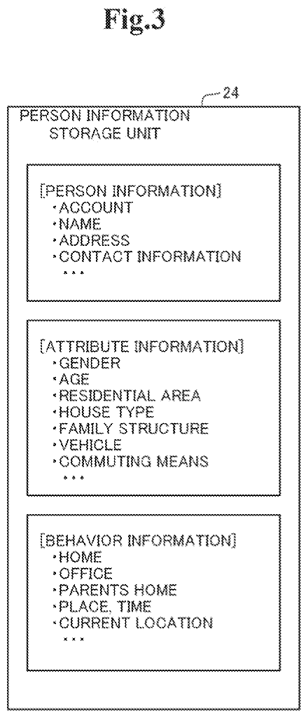

The person's terminal UT has a function of registering, with the issuing device 20, person information (user information) that is information related to the person U automatically or in response to an operation by the person U. For example, the person U transmits and registers person information to and with the issuing device 20 in advance, when the person U desires to be provided with information related to a disaster. Here, person information includes individual information that is information related to the person U and the relatives, attribute information representing attributes of the person U, and behavior information representing the behavior of the person U, and the like, as illustrated in FIG. 3. FIG. 3 illustrates examples of person information stored in the person information storage unit 24 formed in the issuing device 20. The person information includes name, address, names of the family, address of the family, contact information (email address or the like), and the like, for example. The attribute information includes gender, age, residential area, house type (detached house, apartment, or the like), family structure, having or not having a car, commuting means (by train, by car, by walk, or the like), and the like, for example. The behavior information includes home address of the person U, office address, parent's home address, visited place, current place, and the like.

The person's terminal UT transmits and registers, to and with the issuing device 20, the individual information registered with the installed application, and the behavior information based on the behavior of the person U acquired by the application, automatically or in response to an operation by the person U. However, the person information described above may be registered with the issuing device 20 by means of any method.

The person's terminal UT has a function of receiving provided information provided at the time of a disaster from the issuing device 20 and outputting it to the person U. For example, the person's terminal UT outputs sound information, provided as provided information, from a loudspeaker, or displays image information such as a still image and a moving image on a display screen. However, the person's terminal UT may receive and output provided information provided from the issuing device 20 even in the normal time, without being limited to the time of a disaster. In that case, the person's terminal UT is provided with provided information from the issuing device 20 when the person's terminal UT requests the issuing device 20 for the provided information in the normal time.

The issuance determination device 10 is an information processing device managed by an institution such as a local government, a central government, or a professional service provider. In the issuance determination device 10, an arithmetic device installed therein executes a program, whereby the issuance determination device 10 has a function of analyzing information of a disaster caused by a natural phenomenon such as an earthquake, tsunami, typhoon, heavy rain, flood, snow, or landslide or an artificial reason, and determining whether or not to issue a warning. Then, when determining to issue a warning, the issuance determination device 10 has a function of notifying the issuing device 20 of disaster content information representing the content of the disaster, along with an instruction to issue a warning. The disaster content information includes the place where a disaster may occur (area, address, or the like), the disaster type (earthquake, tsunami, typhoon, heavy rain, flood, snow, landslide, or the like), and the disaster level (seismic intensity, rainfall amount, wind speed, wave height, alert level, or the like). The disaster content information also includes weather information for each location (area) for example, as information related to the disaster. However, the disaster content information is not limited to the information having the content described above.

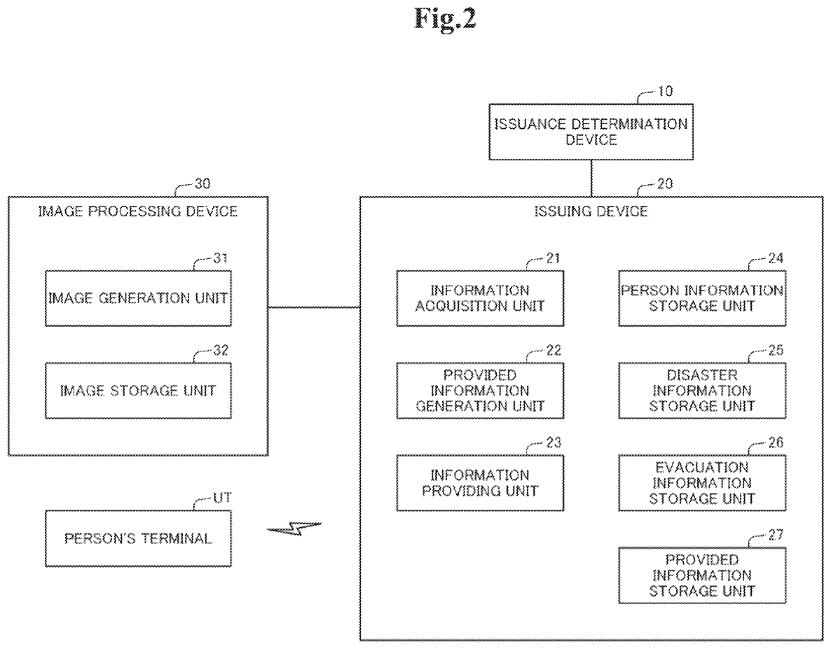

The issuing device 20 has a function of providing the person's terminal UT with provided information related to a disaster, upon receiving a notice of the disaster content information from the issuance determination device 10. For example, the issuing device 20 is configured of one or a plurality of information processing devices installed on a network. As illustrated in FIG. 2, the issuing device 20 includes an information acquisition unit 21, a provided information generation unit 22, and an information providing unit 23 that are constructed by execution of a program by the arithmetic device. The issuing device 20 also includes a person information storage unit 24, a disaster information storage unit 25, an evacuation information storage unit 26, and a provided information storage unit 27 that are formed in the storage device. Hereinafter, the respective constituent elements will be described.

The information acquisition unit 21 (acquisition means) acquires person information that is information related to the person U transmitted from the person's terminal UT by a registration operation using the person's terminal UT by the person U who desires to be provided with provided information related to a disaster, and stores the information in the person information storage unit 24. The person information includes the individual information, the attribute information, and the behavior information, as illustrated in FIG. 3. However, the information acquisition unit 21 may acquire the person information at any timing, without being limited to acquiring it at the time of registration by the person U who desires to be provided with provided information. For example, the information acquisition unit 21 may acquire the person information together with a request for the provided information from the person's terminal UT of the person U at the time of occurrence of a disaster or in the normal time. Moreover, the information acquisition unit 21 may acquire the person information from another information processing system, without being limited to acquiring it from the person's terminal U operated by the person U. The information acquisition unit 21 may regularly acquire information representing the current location of the person's terminal UT of the person U whose person information has been registered, and store it while including it in the behavior information.

The information acquisition unit 21 acquires the disaster content information notified from the issuance determination device 10, and stores it in the disaster information storage unit 25. The disaster content information includes the place where a disaster may occur (area, address, or the like), the disaster type (earthquake, tsunami, typhoon, heavy rain, flood, snow, landslide, or the like), the disaster level (seismic intensity, rainfall amount, wind speed, wave height, alert level, or the like), weather information, and the like, as described above.

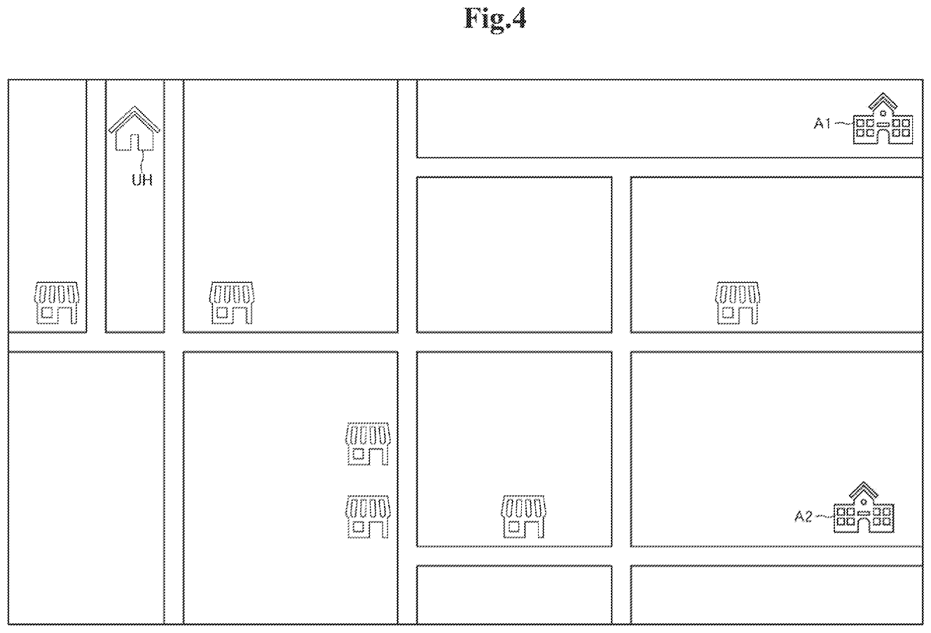

The information acquisition unit 21 also acquires refuge information that is information related to a refuge, and stores it in the evacuation information storage unit 26. The refuge information is map information including road information as illustrated in FIG. 4 for example, including the names of the refuges and locations of refuges A1 and A2 on the map. Note that the refuge information may be one acquired by the issuing device 20 from an information processing device operated by an institution such as a central government or a local government over a network, or may be one acquired by any method.

The provided information generation unit 22 (generation means) generates provided information related to a disaster to be provided to the person U, upon receiving a notice of the disaster content information from the issuance determination device 10. In particular, the provided information generation unit 22 generates, for the person U, provided information including a disaster image (captured image) with which the person U can recognize the situation of the disaster.

Specifically, the provided information generation unit 22 first reads out the person information of the person U to whom provided information is to be provided, stored in the person information storage unit 24, and the disaster content information stored in the disaster information storage unit 25. Then, the provided information generation unit 22 acquires contact information such as an email address from the individual information of the person information of the person U, and sets it as a transmission destination of the provided information to be generated. The provided information generation unit 22 also notifies the image processing device 30 of the attribute information and the behavior information in the person information and the disaster content information, to request generation of a disaster image. Generation of a disaster image by the image processing device 30 will be described in detail later in the description of the configuration of the image processing device 30.

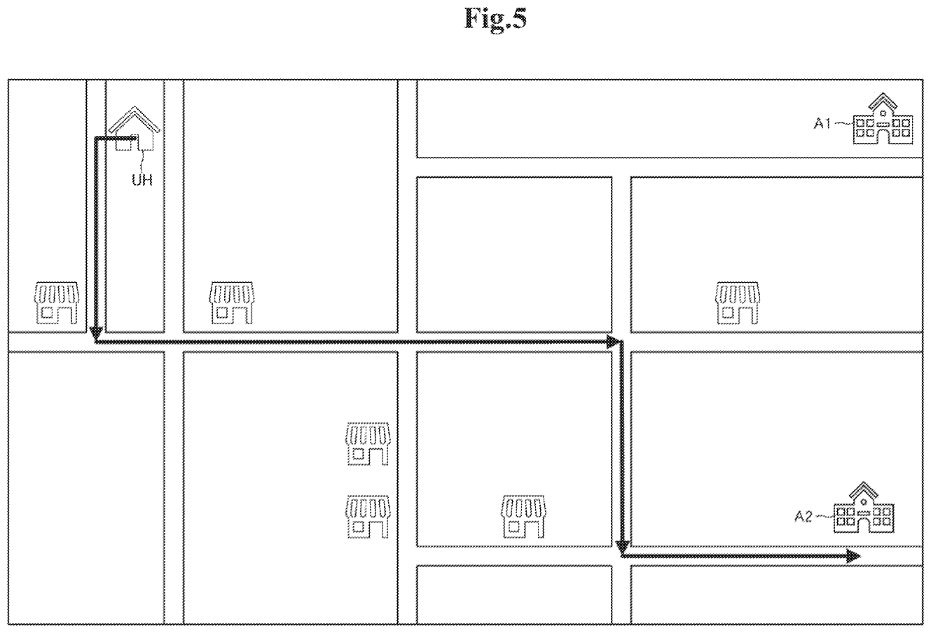

Then, when receiving a disaster image generated and transmitted by the image processing device 30, the provided information generation unit 22 includes the disaster image in the provided information and stores it in the provided information storage unit 27. Along with it, the provided information generation unit 22 generates evacuation information including the refuge to which the person U should evacuate and the evacuation route by using the refuge information and the person information, and includes it in the provided information and stores it in the provided information storage unit 27. Specifically, as illustrated in FIG. 5, the provided information generation unit 22 generates an evacuation route in which the home address UH of the person U included in the person information is the place of departure and one of the refuges A1 and A2 is the destination, on the map information as illustrated in FIG. 4. At that time, as an example, the provided information generation unit 22 generates an evacuation route in which the person U can reach one of the refuges A1 and A2 with the shortest distance from the home address UH of the person U. However, the provided information generation unit 22 may generate an evacuation route by any method. For example, the provided information generation unit 22 may generate an evacuation route in which the current location of the person U is set as the place of departure with reference to the behavior information in the person information of the person U, may generate an evacuation route in which a refuge that is near the place where the person U often visits is set as the place of destination, or may generate an evacuation route bypassing the area where the disaster has occurred with reference to the disaster content information.

The provided information generation unit 22 includes the disaster content information in the provided information including the disaster image and the evacuation information generated as described above, and stores them in the provided information storage unit 27. That is, the provided information also includes information about the place where a disaster may occur, the disaster type, and the disaster level. However, the provided information generation unit 22 is not necessarily limited to generate provided information having the content described above. For example, the provided information may be configured of part of the above-described information such as information only including a disaster image, or may include information other than that described above.

The information providing unit 23 (providing means) transmits the provided information generated as described above and stored in the provided information storage unit 27 to the person's terminal UT of the person U. At that time, the information providing unit 23 transmits, to the email address set as a transmission destination as described above, the provided information including the disaster image generated based on the person information of the person U of the email address.

The image processing device 30 has a function of collecting and accumulating images and processing images. For example, the image processing device 30 is configured of one or a plurality of information processing devices installed on a network. As illustrated in FIG. 2, the image processing device 30 includes an image generation unit 31 that is constructed by execution of a program by the arithmetic device. The image processing device 30 also includes an image storage unit 32 formed in the storage device. Hereinafter, the respective constituent elements will be described.

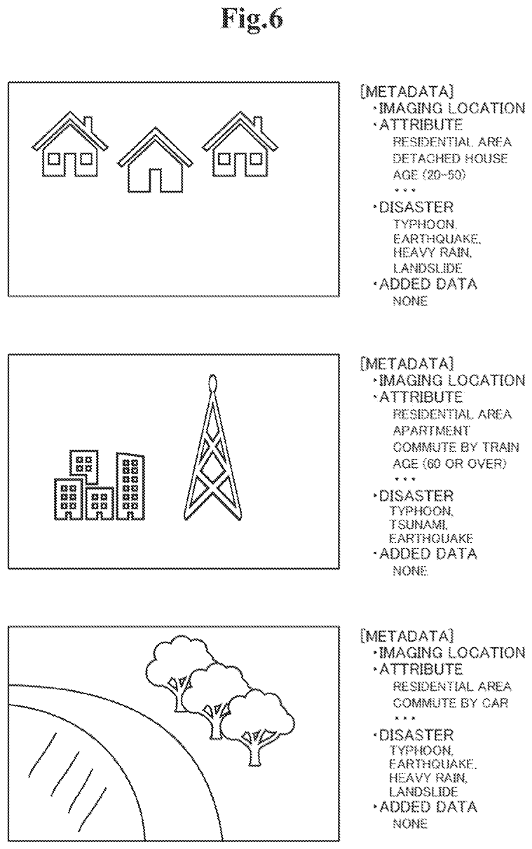

The image storage unit 32 stores a captured image that is an image in which a predetermined place is captured. Captured images may be an image of a “detached house” that is the home of the person U or a house at a predetermined address as illustrated in the upper drawing of FIG. 6, an image of the “AA tower” that is an old building well-known by the citizens as illustrated in the intermediate drawing of FIG. 6, an image of a “forest road” as illustrated in the lower drawing of FIG. 6, and the like. However, the captured images stored in the image storage unit 32 may be images of any places. A captured image is associated with metadata as illustrated in FIG. 6, and is stored in the image storage unit 32. Metadata includes, for example, the capturing location (address) of the captured image, an attribute corresponding to the attribute information of the person U, the disaster type corresponding to the disaster content information, and the like.

The “capturing location (address)” of the metadata is information that is measured by a position measuring device such as a global positioning system (GPS) mounted on a camera at the time of imaging, and is automatically associated with the captured image or manually associated by the operator of the image processing device 30. The “attribute” of the metadata is information that is manually associated by the operator of the image processing device 30, and is set in consideration that for which person, that is, a person U having which attribute, the captured image is appropriate to be used as a disaster image. For example, with a captured image of a “detached house” in the upper drawing of FIG. 6, an attribute of “residential area” corresponding to the location thereof may be associated, or an attribute that the house type is a “detached house” may be associated. With a captured image of the “AA tower” in the intermediate drawing of FIG. 6, an attribute of “residential area” corresponding to the location thereof, or an attribute of “age (60 or over)” is associated because it is a famous building that elderly persons have been seen. With a captured image of a “forest road” in the lower drawing of FIG. 6, an attribute of “residential area” corresponding to the location thereof or an attribute that the commuting means is “commute by car” is associated. The “disaster” of the metadata is information that is manually associated by the operator of the image processing device 30, and is set in consideration that for which disaster type, among a plurality of disaster types, the captured image is appropriate to be used as a disaster image. Note that the metadata described above is an example, and another type of information may be associated with the captured image.

The image generation unit 31 (generation means) generates a disaster image by using an image stored in the image storage unit 32, when receiving a request for generating a disaster image from the issuing device 20 as described above. Then, the image generation unit 31 sends back a disaster image, generated as described above, to the requesting issuing device 20.

Specifically, the image generation unit 31 selects a captured image stored in the image storage unit 32 on the basis of the attribute information, the behavior information, and the disaster content information in the person information notified from the issuing device 20, and generates a disaster image by using the selected captured image. For example, the image generation unit 31 selects a captured image associated with an imaging location and an attribute corresponding to the notified attribute information (residential area, age, house type, and the like) of the person U, selects a captured image associated with an imaging location corresponding to the notified behavior information (home, office, and the like) of the person U, or selects a captured image associated with an imaging location and a disaster type corresponding to the notified disaster content information (place of disaster, disaster type, and the like). Note that the image generation unit 31 may select a captured image corresponding to one type of information among a plurality of types of information notified from the issuing device 20, or select captured images corresponding to a plurality of types of information.

Then, the image generation unit 31 generates a disaster image while adding, to the selected captured image, image information representing a situation that may occur due to the disaster on the basis of the disaster content information. For example, in the case where the type of information in the disaster content information is “typhoon”, image information representing a situation of “inundation” may be added. When the disaster type in the disaster content information is “earthquake”, image information representing a situation of “landslide” may be added. At that time, according to the degree of disaster level in the disaster content information, image information in which the degree of “inundation” or the degree of “landslide” is set may be added.

The image generation unit 31 may generate a disaster image while adding, to the selected captured image, image information representing a situation that may occur due to the disaster each time a predetermined time has passed. For example, in the case where a disaster image to which image information of “inundation” is added is generated as a disaster image after one hour from the current time, the image generation unit 31 generates a disaster image to which image information of a higher degree of “inundation” is added, as a disaster image after two hours. The image generation unit 31 may also generate a disaster image while adding, to the selected captured image, image information representing a situation that may occur according to the weather information on the basis of the weather information included in the disaster content information. For example, the image generation unit 31 may generate a disaster image to which image information of raining is added, or may generate a disaster image to which image information having a higher degree of “inundation” caused by the rain is added.

Note that the image generation unit 31 has an image processing function corresponding to disaster content information that is performed by execution of a program. As an example, the image generation unit 31 stores an “inundation” image corresponding to the disaster type “typhoon” in advance, and also has a function of setting the degree of inundation and synthesizing the “inundation” image on the captured image. As another example, the image generation unit 31 stores a “rain” image and an “inundation” image corresponding to the weather information “rain” in advance, and has a function of setting the degree of inundation and synthesizing the “inundation” image and the “rain” image on the captured image. As still another example, corresponding to the disaster type “landslide”, the image generation unit 31 has a function of detecting a precipice in the captured image and converting the image such that the precipice crumbles down.

Here, an example of selecting a captured image and generating a disaster image from the captured image by the image generation unit 31 will be described with reference to FIGS. 7A to 7D. In the example of FIG. 7A, the image generation unit 31 first focuses on the home address in the notified behavior information of the person U and the place of disaster in the notified disaster content information, and selects a captured image (upper drawing) in which the imaging location corresponding to the home and the place of disaster is included in the metadata. Then, the image generation unit 31 focuses on the disaster type and the disaster level in the notified disaster content information, and when the disaster type is typhoon, generates a disaster image (lower drawing) by adding the image information representing the degree of “inundation” corresponding to the disaster level to the selected captured image. Thereafter, the image generation unit 31 adds the added content of the added image information (in this case, inundation) to the metadata of the generated disaster image.

In the example of FIG. 7B, the image generation unit 31 first focuses on the commuting means in the notified attribute information of the person U, and when the information is “commute by car”, selects a captured image (upper drawing) in which the same information is included in the metadata. Then, the image generation unit 31 focuses on the disaster type and the disaster level in the notified disaster content information. Since the disaster type is earthquake, the image generation unit 31 generates a disaster image (lower drawing) by adding image information representing the degree of “landslide” corresponding to the disaster level to the selected captured image.

In the example of FIG. 7C, the image generation unit 31 first focuses on the house type in the notified attribute information of the person U, and when the information is “detached house”, selects a captured image (upper drawing) in which the same information is included in the metadata. Then, the image generation unit 31 focuses on the disaster type and the disaster level in the notified disaster content information. Since the disaster type is typhoon, the image generation unit 31 generates a disaster image (intermediate drawing) by adding image information representing “inundation” of the level corresponding to the rainfall amount after one hour from the current time to the selected captured image. At that time, the image generation unit 31 may add image information representing the image of the person U to the captured image. Then, the image generation unit 31 further generates a disaster image (lower drawing) by adding image information representing “inundation” of the degree corresponding to the rainfall amount after two hours from the current time, that is, image information representing “inundation” with a higher water level.

In the example of FIG. 7D, the image generation unit 31 first focuses on the house type in the notified attribute information of the person U, and when the information is “detached house”, selects a captured image (upper drawing) in which the same information is included in the metadata. Then, the image generation unit 31 focuses on the disaster type and the disaster level in the notified disaster content information. Since the disaster type is typhoon, the image generation unit 31 generates a disaster image (intermediate drawing) by adding image information representing the degree of “inundation” corresponding to the disaster level to the selected captured image. The image generation unit 31 further focuses on the home address in the notified behavior information of the person U and the weather information in the notified disaster content information, and since the weather of the home address of the person U is rain, the mage generation unit 31 generates a disaster image (lower drawing) by further adding image information representing “rain” to the captured image.

The image generation unit 31 may generate a disaster image in which image information representing a situation of a disaster is added to a captured image as described above in advance, and stores it in the image storage unit 32. That is, the image generation unit 31 may generate disaster images as illustrated in FIGS. 7A to 7D from the captured image illustrated in FIG. 6, regardless of presence or absence of a disaster and regardless of presence or absence of a request for generating a disaster image from the issuing device 20. In that case, corresponding to any disaster types and weather information, the image generation unit 31 generates disaster images by adding, to the captured image, image information representing situations that may occur due to disasters or weather. Then, the image generation unit 31 adds, to the metadata of the disaster image, information representing the content of the added image information, that is, inundation, landslide, and rain, for example, as added data.

Then, when receiving a request for generating a disaster image from the issuing device 20 thereafter, the image generation unit 31 selects an already generated disaster image stored in the image storage unit 32, on the basis of the attribute information and the behavior information of the person and the disaster content information notified from the issuing device 20. For example, the image generation unit 31 first selects disaster images in which the notified attribute information and behavior information of the person and information corresponding to the disaster type in the disaster content information are associated with the metadata, and then, finally selects a disaster image to which added data corresponding to the disaster type in the disaster content information is added. As an example, in the case where the disaster type in the disaster content information is “typhoon”, a disaster image to which information of “inundation” is added as added data is finally selected. Then, the image generation unit 31 sends back a finally selected disaster image to the requesting issuing device 20.

[Operation]

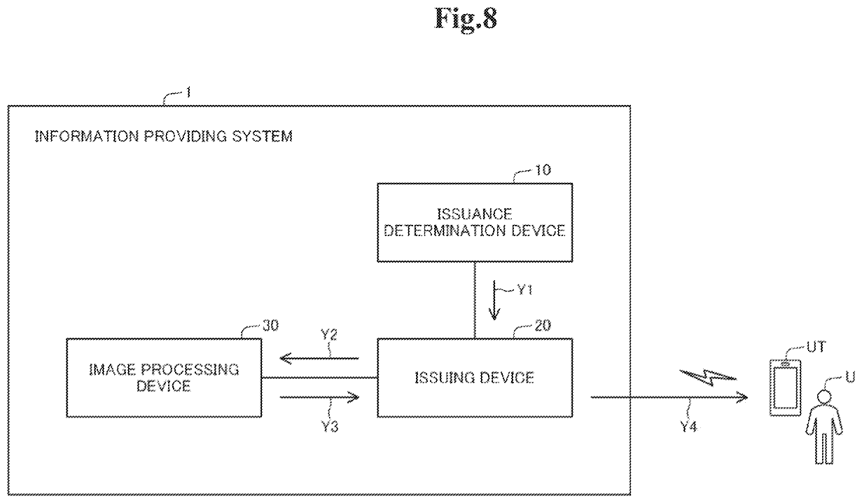

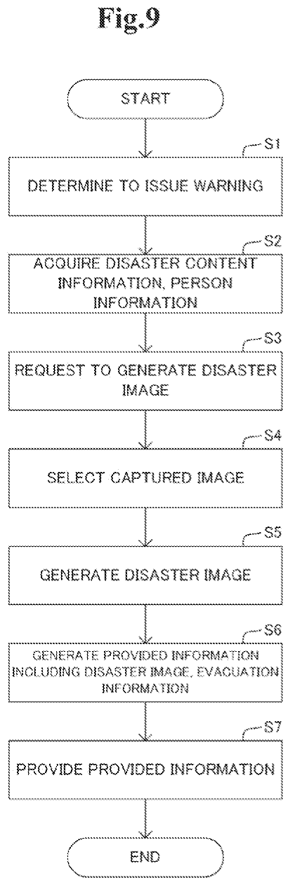

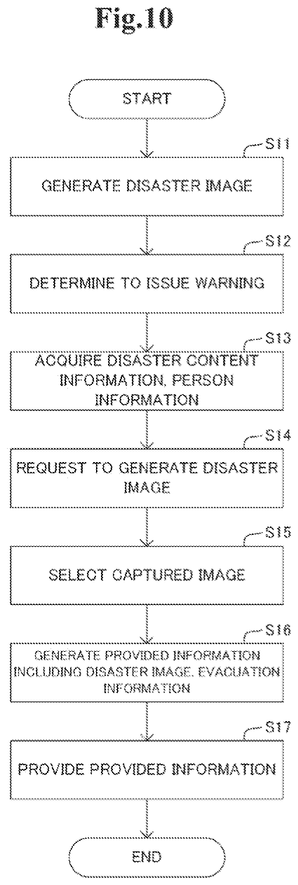

Next, operation of the information processing system as described above will be described with reference to FIGS. 8 to 10 mainly. FIG. 8 is a diagram illustrating the flow of information between devices in the information processing system, and FIGS. 9 and 10 are flowcharts illustrating the operation of the entire information processing system. In particular, the flowchart of FIG. 9 illustrates the case of generating a disaster image when a disaster occurs, and the flowchart of FIG. 10 illustrates the case of generating a disaster image in advance. First, the flowchart of FIG. 9 will be described.

The issuance determination device 10 collects and analyzes information related to a disaster, and determines whether or not to issue a warning. Then, when determining to issue a warning, the issuance determination device 10 notifies the issuing device 20 of disaster content information representing the content of the disaster, along with an instruction to issue a warning (arrow Y1 in FIG. 8, step S1 in FIG. 9). The disaster content information includes the place where a disaster may occur (area, address, or the like), the disaster type (earthquake, tsunami, typhoon, heavy rain, flood, snow, landslide, or the like), and the disaster level (seismic intensity, rainfall amount, wind speed, wave height, alert level, or the like). The disaster content information also includes weather information for each location (area) for example, as information related to the disaster.

Then, when receiving a notice of the disaster content information from the issuance determination device 10, the issuing device 20 acquires the disaster content information and also acquires person information of the person U registered in advance (step S2 in FIG. 9). The issuance device 20 may acquire person information of the person U transmitted from the person's terminal UT when the person U requests to be provided with information using the person's terminal, at the time of occurrence of a disaster or at any timing in the normal state.

Then, the issuing device 20 notifies the image processing device 30 of the acquired disaster content information and the person information, and requests to generate a disaster image (arrow Y2 in FIG. 8, step S3 in FIG. 9). Upon receiving such a request, the image processing device 30 selects a captured image corresponding to the disaster content information and the person information from among the captured images stored in advance (step S4 in FIG. 9). Here, the image processing device 30 stores therein captured images as illustrated in FIG. 6 in advance for example, and each captured image is associated with the imaging location, attributes, and the disaster type corresponding to the content of the image as metadata. Then, the image processing device 30 selects a captured image that is associated with metadata corresponding to the place of disaster and the disaster type included in the notified disaster content information, and the attribute information and the behavior information in the notified person information.

As an example, when an attribute of the person U is “house type: detached house”, the image processing device 30 selects a captured image of “detached house” illustrated in the upper drawing of FIG. 6, when an attribute of the person U is “age: 60 or over”, selects a captured image of “AA tower” illustrated in the intermediate drawing of FIG. 6 that is an old famous building known by a person of age 60 or over, and when an attribute of the person U is “commuting means: commute by car”, selects a captured image of “forest road” illustrated in the lower drawing of FIG. 6. As another example, the image processing device 30 may specify the “home” from the behavior information of the person U, and select a captured image of “detached house” illustrated in the upper drawing of FIG. 6 corresponding to the home address. As still another example, the image processing device 30 may specify the disaster type from the disaster content information, and selects a captured image associated with a disaster type that is the same as the specified disaster type. The image processing device 30 may select a captured image corresponding to a plurality of types of information among the notified disaster content information and person information.

Then, the issuing device 20 generates a disaster image while adding, to the selected captured image, image information representing a situation that may occur due to the disaster according to the notified disaster content information (step S5 in FIG. 9). As an example, in the case where the disaster type in the disaster content information is “typhoon”, the issuing device 20 adds image information representing a situation of “inundation” as illustrated in FIG. 7A. When the disaster type in the disaster content information is “earthquake”, the issuing device 20 adds image information representing a situation of “landslide” as illustrated in FIG. 7B. As another example, the issuing device 20 may generate a disaster image added with image information representing a situation of “inundation” that is estimated after one hour and two hours from the current time, that is, estimated each time a predetermined time has passed, as illustrated in FIG. 7C. As still another example, the issuing device 20 may generate a disaster image added with a situation that may occur according to the weather information included in the disaster content information, that is, image information of raining as illustrated in FIG. 7D.

Then, the image processing device 30 sends back a disaster image, generated as described above, to the issuing device 20 (arrow Y3 in FIG. 8). The issuing device 20 receives the disaster image, and generates provided information including the disaster image (step S6 in FIG. 9). Before or after the generation of the disaster image as described above, the issuing device 20 generates evacuation information including a refuge to which the person U should evacuate and the evacuation route by using the refuge information and the person information, and includes it in the provided information.

Then, the issuing device 20 transmits the provided information including the disaster image and the evacuation information by using the email address in the person information as a transmission destination, to thereby provide the person's terminal of the person U with the provided information (arrow Y4 in FIG. 8, step S7 in FIG. 9). As a result, the person U allows the disaster image and the evacuation information to be displayed on the display device of the person's terminal UT. Note that when an image representing a situation each time a predetermined time has passed as illustrated in FIG. 7C is displayed as a disaster image, the person's terminal UT may show an operation unit such as a slide bar for operating the elapse of time on the display device, to display an image corresponding to the set time when the slide bar is operated by the person U to set the elapse of time. For example, in the case where the person's terminal UT is displaying a disaster image representing “inundation” after one hour from the current time, when the slide bar is operated and the time “after two hours” is set, the person's terminal UT displays a disaster image representing “inundation” after two hours from the current time.

Note that when there is no instruction to issue a warning and provided information is requested from the person's terminal UT of the person U at any timing during the normal time, the issuing device 20 may acquire person information of the person U transmitted from the person's terminal UT at that time, and transmit the person information to the image processing device 30 to request generation of a disaster image. In that case, the image processing device 30 may select a captured image corresponding to the person information in the same manner as described above, and generate a disaster image in which image information representing a situation of a disaster corresponding to the disaster type designated by the person U or corresponding to any disaster type is added to the captured image. As a result, the person U can allow a disaster image to be displayed even when a disaster does not occur actually.

Next, another operation of the information processing system will be described with reference to the flowchart of FIG. 10. In this example, the image processing device 30 first generates a disaster image in which image information representing a situation of a disaster corresponding to a disaster type is added to a captured image in advance in the same manner as described above, and stores it (step S11 in FIG. 10). Specifically, according to the disaster type associated with a captured image in advance, the image processing device 30 generates a disaster image in which image information representing a situation of the disaster is added to the captured image. However, the image processing device 30 may generate a disaster image in which image information representing a situation of any disaster type is added to a captured image, and in that case, information representing the situation corresponding to the added image information is associated with the disaster image.

Note that the image processing device 30 may store a captured image that is captured when a disaster occurred at the imaging location previously, as a disaster image. Even in that case, the disaster image is associated with metadata including information such as the imaging location of the captured image, an attribute corresponding to the attribute information of the person U, and the disaster type corresponding to the disaster content information.

Then, the issuance determination device 10 collects and analyzes information related to the disaster, and determines whether or not to issue a warning. Then, when determining to issue a warning, the issuance determination device 10 notifies the issuing device 20 of disaster content information representing the content of the disaster, along with an instruction to issue a warning (arrow Y1 in FIG. 8, step S12 in FIG. 10).

Then, when receiving a notice of the disaster content information from the issuance determination device 10, the issuing device 20 acquires the disaster content information and also acquires the person information of the person U registered in advance (step S13 in FIG. 10). The issuance device 20 may acquire the person information of the person U transmitted from the person's terminal UT when the person U requests to be provided with information using the person's terminal UT, at the time of occurrence of a disaster or at any timing in the normal state.

Then, the issuing device 20 notifies the image processing device 30 of the acquired disaster content information and the person information, and requests to generate a disaster image (arrow Y2 in FIG. 8, step S14). Upon receiving such a request, the image processing device 30 selects a disaster image corresponding to the disaster content information and the person information from among the disaster images stored in advance (step S15 in FIG. 10). In this example, disaster images have been generated by the image processing device 30 as illustrated above, and the imaging location, attributes, and the disaster type corresponding to the content of each image are associated as metadata. Therefore, the image processing device 30 selects a disaster image that is associated with metadata corresponding to the place of disaster and the disaster type included in the notified disaster content information, and the attribute information and the behavior information in the notified person information.

Then, the image processing device 30 sends back the selected disaster image to the issuing device 20 (arrow Y3 in FIG. 8). Then, the issuing device 20 receives the disaster image, and generates provided information including the disaster image (step S16 in FIG. 10). Before or after the generation of the disaster image as described above, the issuing device 20 generates evacuation information including a refuge to which the person U should evacuate and the evacuation route by using the refuge information and the person information, and includes it in the provided information.

Then, the issuing device 20 transmits the provided information including the disaster image and the evacuation information by using the email address in the person information as a transmission destination, to thereby provide the person's terminal of the person U with the provided information (arrow Y4 in FIG. 8, step S17 in FIG. 10). As a result, the person U allows the disaster image and the evacuation information to be displayed on the display device of the person's terminal UT.

Note that when there is no instruction to issue a warning, and provided information is requested from the person's terminal UT of the person U at any timing during the normal time, the issuing device 20 may acquires person information of the person U transmitted from the person's terminal UT at that time, and transmit the person information to the image processing device 30 to request generation of a disaster image. In that case, the image processing device 30 may select disaster images corresponding to the person information in the same manner as described above, and finally selects a disaster image in which image information representing a situation of a disaster corresponding to the disaster type designated by the person U or corresponding to any disaster type is added. As a result, the person U can allow a disaster image to be displayed even when a disaster does not occur actually.

As described above, the present invention uses a captured image in which a place corresponding to the person information according to the attribute and the behavior of the person U is captured, generates a disaster image reflecting a situation of the disaster, and provides the person U with provided information including the disaster image. For example, a disaster image is generated by using a captured image of home of the person U, a captured image in which a place related to the lifestyle of the person U is captured, and a captured image of a building that is known even by an elderly person. Therefore, the person U can visually recognize a disaster image of a place corresponding to himself/herself such as a place close to himself/herself or a place that he/she knows. Accordingly, the interest on the disaster image is increased, whereby the person U can clearly recognize the degree of danger on the disaster. As a result, it is expected that the person U takes an appropriate behavior such as taking measures and evacuation positively on the disaster.

### Second Exemplary Embodiment

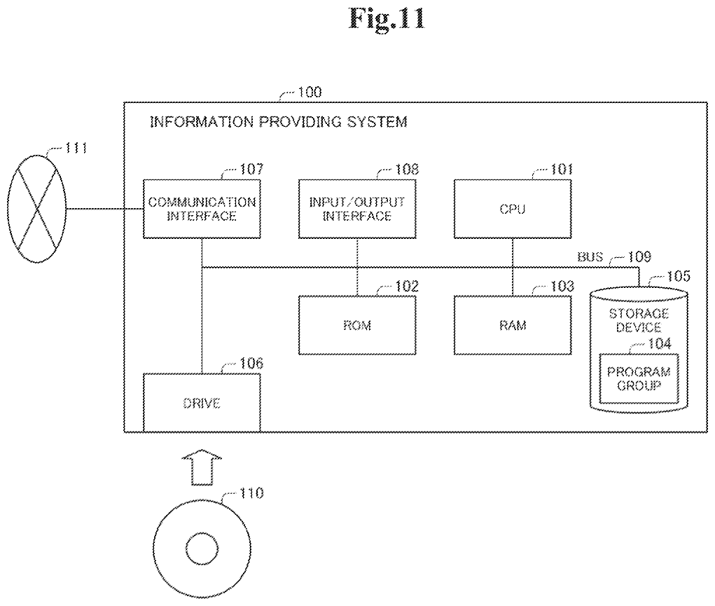

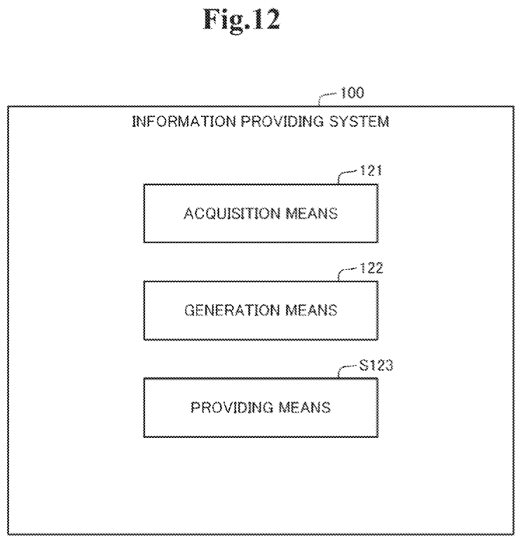

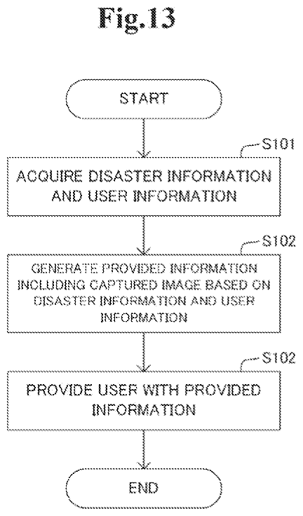

Next, a second exemplary embodiment of the present invention will be described with reference to FIGS. 11 to 13. FIGS. 11 and 12 are block diagrams illustrating the configuration of an information providing system according to the second exemplary embodiment, and FIG. 13 is a flowchart illustrating the operation of the information providing system. Note that the present embodiment shows the outlines of the configurations of the information providing system and the information providing method described in the first exemplary embodiment.

First, a hardware configuration of the information providing system 100 in the present embodiment will be described with reference to FIG. 11. The information providing system 100 is configured of at least one typical information processing device, having a hardware configuration as described below as an example.

Central Processing Unit (CPU) 101 (arithmetic device)

Read Only Memory (ROM) 102 (storage device)

Random Access Memory (RAM) 103 (storage device)

Program group 104 to be loaded to the RAM 303

Storage device 105 storing therein the program group 304

Drive 106 that performs reading and writing on a storage medium 110 outside the information processing device

Communication interface 107 connecting to a communication network 111 outside the information processing device

Input/output interface 108 for performing input/output of data

Bus 109 connecting the constituent elements

The information providing system 100 can construct, and can be equipped with, an acquisition means 121, a generation means 122, and a providing means 123 illustrated in FIG. 12, through acquisition and execution of the program group 104 by the CPU 101. Note that the program group 104 is stored in the storage device 105 or the ROM 102 in advance, and is loaded to the RAM 103 by the CPU 101 as needed. Further, the program group 104 may be provided to the CPU 101 via the communication network 111, or may be stored on the storage medium 110 in advance and read out by the drive 106 and supplied to the CPU 101. However, the acquisition means 121, the generation means 122, and the providing means 123 may be constructed by electronic circuits.

Note that FIG. 11 illustrates an example of a hardware configuration of the information providing system 100. The hardware configuration of the information providing system is not limited to that described above. For example, the information providing system may be configured of part of the configuration described above, such as without the drive 106.

The information providing system 100 executes the information providing method illustrated in the flowchart of FIG. 13, by the functions of the acquisition means 121, the generation means 122, and the providing means 123 constructed by the program as described above.

As illustrated in FIG. 13, the information providing system 100

acquires disaster information and acquires user information that is information related to a user (step S101),

on the basis of the disaster information and the user information, generates provided information including a captured image that is an image obtained by capturing a predetermined place (step S102), and

provides an information processing device of the user with the provided information (step S103).

Since the present embodiment is configured as described above, the present embodiment provides a user with provided information reflecting a situation of a disaster by using a captured image in which a place corresponding to the user information is captured. Accordingly, the user can visually recognize an image of a place corresponding to himself/herself such as a place close to himself/herself or a place that he/she knows. Therefore, the interest on the disaster is increased, and the degree of danger on the disaster can be clearly recognized. As a result, it is expected that the user takes an appropriate behavior such as taking measures and evacuation positively on the disaster.

<Supplementary Notes>

The whole or part of the exemplary embodiments disclosed above can be described as the following supplementary notes. Hereinafter, outlines of the configurations of an information providing method, an information providing system, and a program, according to the present invention, will be described. However, the present invention is not limited to the configurations described below.

### (Supplementary Note 1)

An information providing method comprising:

acquiring disaster information, and acquiring user information that is information related to a user;

on a basis of the disaster information and the user information, generating provided information including a captured image that is an image obtained by capturing a predetermined place; and

providing an information processing device of the user with the provided information.

### (Supplementary Note 2)

The information providing method according to supplementary note 1, further comprising:

acquiring attribute information representing an attribute of the user as the user information; and

generating the provided information on a basis of the disaster information and the attribute information.

### (Supplementary Note 3)

The information providing method according to supplementary note 2, further comprising

acquiring the captured image in which a place corresponding to the attribute information is captured, and generating the provided information including the captured image.

### (Supplementary Note 4)

The information providing method according to any of supplementary notes 1 to 3, further comprising:

acquiring behavior information that is information representing behavior of the user as the user information; and

generating the provided information on a basis of the disaster information and the behavior information.

### (Supplementary Note 5)

The information providing method according to supplementary note 4, further comprising

acquiring the captured image in which a place corresponding to the behavior information is captured, and generating the provided information including the captured image.

### (Supplementary Note 6)

The information providing method according to any of supplementary notes 1 to 5, further comprising:

acquiring disaster content information that is information representing a content of a disaster as the disaster information; and

generating the provided information on a basis of the disaster content information.

### (Supplementary Note 7)

The information providing method according to supplementary note 6, further comprising

on a basis of the disaster content information, acquiring the captured image including image information representing a situation having a possibility of occurrence due to the disaster, and generating the provided information including the captured image.

### (Supplementary Note 8)

The information providing method according to supplementary note 6, further comprising

on a basis of the disaster content information, generating the provided information in which image information representing a situation having a possibility of occurrence due to the disaster is added to the captured image.

### (Supplementary Note 9)

The information providing method according to supplementary note 8, further comprising:

on the basis of the disaster content information, generating the provided information in which image information representing a situation having a possibility of occurrence after elapse of a predetermined time due to the disaster is added to the captured image.

### (Supplementary Note 10)

The information providing method according to any of supplementary notes 1 to 9, further comprising:

acquiring location information representing a location of the user as the user information; and

generating evacuation information including information specifying at least an evacuation place on a basis of the location information, and providing the information processing device of the user with the evacuation information.

### (Supplementary Note 11)

The information providing method according to any of supplementary notes 1 to 10, further comprising:

acquiring and storing the captured image including position information of an imaged place; and

on a basis of the disaster information and the user information, acquiring the stored captured image and generating the provided image including the stored captured image.

### (Supplementary Note 12)

An information providing system comprising:

acquisition means for acquiring disaster information and acquiring user information that is information related to a user;

generation means for, on a basis of the disaster information and the user information, generating provided information including a captured image that is an image obtained by capturing a predetermined place; and

providing means for providing an information processing device of the user with the provided information.

### (Supplementary Note 13)

The information providing system according to supplementary note 12, wherein

the acquisition means acquires attribute information representing an attribute of the user as the user information, and

the generation means generates the provided information on a basis of the disaster information and the attribute information.

### (Supplementary Note 14)

The information providing system according to supplementary note 13, wherein

the generating means acquires the captured image in which a place corresponding to the attribute information is captured, and generates the provided information including the captured image.

### (Supplementary Note 15)

The information providing system according to any of supplementary notes 12 to 14, wherein

the acquisition means acquires behavior information that is information representing behavior of the user as the user information, and

the generation means generates the provided information on a basis of the disaster information and the behavior information.

### (Supplementary Note 16)

The information providing system according to supplementary note 15, wherein

the generation means acquires the captured image in which a place corresponding to the behavior information is captured, and generates the provided information including the captured image.

### (Supplementary Note 17)

The information providing system according to any of supplementary notes 12 to 16, wherein

the acquisition means acquires disaster content information that is information representing a content of a disaster as the disaster information, and

the generation means generates the provided information on a basis of the disaster content information.

### (Supplementary Note 18)

The information providing system according to supplementary note 17, wherein

on a basis of the disaster content information, the generation means acquires the captured image including image information representing a situation having a possibility of occurrence due to the disaster, and generates the provided information including the captured image.

### (Supplementary Note 19)

The information providing system according to supplementary note 17, wherein

on a basis of the disaster content information, the generation means generates the provided information in which image information representing a situation having a possibility of occurrence due to the disaster is added to the captured image.

### (Supplementary Note 20)

The information providing system according to supplementary note 19, wherein

on the basis of the disaster content information, the generation means generates the provided information in which image information representing a situation having a possibility of occurrence after elapse of a predetermined time due to the disaster is added to the captured image.

### (Supplementary Note 21)

The information providing system according to any of supplementary notes 12 to 20, wherein

the acquisition means acquires location information representing a location of the user as the user information, and

the providing means generating evacuation information including information specifying at least an evacuation place on a basis of the location information, and provides the information processing device of the user with the evacuation information.

### (Supplementary Note 22)

The information providing system according to any of supplementary notes 12 to 21, wherein

the acquisition means acquires and stores the captured image including position information of an imaged place, and

on a basis of the disaster information and the user information, the generation means acquires the stored captured image and generates the provided image including the stored captured image.

### (Supplementary Note 23)

A program for causing an information processing device to execute processing to

acquire disaster information, and acquire user information that is information related to a user;

on a basis of the disaster information and the user information, generate provided information including a captured image that is an image obtained by capturing a predetermined place; and

provide an information processing device of the user with the provided information.

Note that the program described above can be supplied to a computer by being stored on a non-transitory computer-readable medium of any type. Non-transitory computer-readable media include tangible storage media of various types. Examples of non-transitory computer-readable media include magnetic storage media (for example, flexible disk, magnetic tape, and hard disk drive), magneto-optical storage media (for example, magneto-optical disk), a CD-ROM (Read Only Memory), a CD-R, a CD-R/W, and semiconductor memories (for example, mask ROM, PROM (Programmable ROM), EPROM (Erasable PROM), a flash ROM, and a RAM (Random Access Memory)). Note that the program may be supplied to a computer by being stored on a transitory computer-readable medium of any type. Examples of transitory computer-readable media include electric signals, optical signals, and electromagnetic waves. A transitory computer-readable medium can be supplied to a computer via a wired communication channel such as a wire and an optical fiber, or a wireless communication channel.

While the present invention has been described with reference to the exemplary embodiments described above, the present invention is not limited to the above-described embodiments. The form and details of the present invention can be changed within the scope of the present invention in various manners that can be understood by those skilled in the art.

### REFERENCE SIGNS LIST

1 information providing system
10 issuance determination device
20 issuing device
21 information acquisition unit
22 provided information generation unit
23 information providing unit
24 person information storage unit
25 disaster information storage unit
26 evacuation information storage unit
27 provided information storage unit
30 image processing device
31 image generation unit
32 image storage unit
U person
UT person's terminal
100 information providing system
101 CPU
102 ROM
103 RAM
104 program group
105 storage device
106 drive
107 communication interface
108 input/output interface
109 bus
110 storage medium
111 communication network
121 acquisition means
122 generation means
123 providing means

What is claimed is:

1. An information providing method comprising:
acquiring disaster information, and acquiring user information that is information related to a user;
on a basis of the disaster information and the user information, generating provided information including a captured image that is an image obtained by capturing a predetermined place; and
providing an information processing device of the user with the provided information.

2. The information providing method according to claim 1, further comprising:
acquiring attribute information representing an attribute of the user as the user information; and
generating the provided information on a basis of the disaster information and the attribute information.

3. The information providing method according to claim 2, further comprising
acquiring the captured image in which a place corresponding to the attribute information is captured, and generating the provided information including the captured image.

4. The information providing method according to claim 1, further comprising:
acquiring behavior information that is information representing behavior of the user as the user information; and
generating the provided information on a basis of the disaster information and the behavior information.

5. The information providing method according to claim 4, further comprising
acquiring the captured image in which a place corresponding to the behavior information is captured, and generating the provided information including the captured image.

6. The information providing method according to claim 1, further comprising:
acquiring disaster content information that is information representing a content of a disaster as the disaster information; and
generating the provided information on a basis of the disaster content information.

7. The information providing method according to claim 6, further comprising
on a basis of the disaster content information, acquiring the captured image including image information representing a situation having a possibility of occurrence due to the disaster, and generating the provided information including the captured image.

8. The information providing method according to claim 6, further comprising
on a basis of the disaster content information, generating the provided information in which image information representing a situation having a possibility of occurrence due to the disaster is added to the captured image.

9. The information providing method according to claim 8, further comprising:
on the basis of the disaster content information, generating the provided information in which image information representing a situation having a possibility of occurrence after elapse of a predetermined time due to the disaster is added to the captured image.

10. The information providing method according to claim 1, further comprising:
acquiring location information representing a location of the user as the user information; and
generating evacuation information including information specifying at least an evacuation place on a basis of the location information, and providing the information processing device of the user with the evacuation information.

11. The information providing method according to claim 1, further comprising:
acquiring and storing the captured image including position information of an imaged place; and
on a basis of the disaster information and the user information, acquiring the stored captured image and generating the provided image including the stored captured image.

12. An information providing system comprising:
at least one memory configured to store instructions; and
at least one processor configured to execute instructions to:
acquire disaster information and acquire user information that is information related to a user;
on a basis of the disaster information and the user information, generate provided information including a captured image that is an image obtained by capturing a predetermined place; and
provide an information processing device of the user with the provided information.

13. The information providing system according to claim 12, wherein the at least one processor is configured to execute the instructions to:
acquire attribute information representing an attribute of the user as the user information; and
generate the provided information on a basis of the disaster information and the attribute information.

14. The information providing system according to claim 13, wherein the at least one processor is configured to execute the instructions to
acquire the captured image in which a place corresponding to the attribute information is captured, and generate the provided information including the captured image.

15. The information providing system according to claim 12, wherein the at least one processor is configured to execute the instructions to:
acquire behavior information that is information representing behavior of the user as the user information; and
generate the provided information on a basis of the disaster information and the behavior information.

16. The information providing system according to claim 15, wherein the at least one processor is configured to execute the instructions to
acquire the captured image in which a place corresponding to the behavior information is captured, and generate the provided information including the captured image.

17. The information providing system according to claim 12, wherein the at least one processor is configured to execute the instructions to:
acquire disaster content information that is information representing a content of a disaster as the disaster information; and
generate the provided information on a basis of the disaster content information.

18. The information providing system according to claim 17, wherein the at least one processor is configured to execute the instructions to
on a basis of the disaster content information, acquire the captured image including image information representing a situation having a possibility of occurrence due to the disaster, and generate the provided information including the captured image.

19. The information providing system according to claim 17, wherein the at least one processor is configured to execute the instructions to
on a basis of the disaster content information, generate the provided information in which image information representing a situation having a possibility of occurrence due to the disaster is added to the captured image.

20-22. (canceled)

23. A non-transitory computer-readable medium storing thereon a program comprising instructions for causing an information processing device to execute processing to
acquire disaster information, and acquire user information that is information related to a user;
on a basis of the disaster information and the user information, generate provided information including a captured image that is an image obtained by capturing a predetermined place; and
provide an information processing device of the user with the provided information.
